(19) United States
(12) Patent Application Publication
(10) Pub. No.: US 2023/0417016 A1
(43) Pub. Date: Dec. 28, 2023

(54) Construction Machine

(71) Applicant: JDC Corporation, Tokyo (JP)

(72) Inventors: Masakazu Sekiguchi, Tokyo (JP); Hidetoshi Morimoto, Tokyo (JP); Hiroshi Obata, Tokyo (JP); Tsukasa Baba, Tokyo (JP)

(21) Appl. No.: 18/252,454

(22) PCT Filed: Sep. 27, 2021
(86) PCT No.: PCT/JP2021/035280

§ 371 Date: May 10, 2023

Related U.S. Application Data
(60) Provisional application No. 63/128,215, filed on Dec. 21, 2020.

(51) Int. Cl. E02F 9/08; B64U 70/93; E02F 9/20; B60L 50/75; B60L 8/00

(52) U.S. Cl. CPC E02F 9/0883; B64U 70/93; E02F 9/207; B60L 50/75; B60L 8/003; B60L 2200/40

(57) ABSTRACT

A construction machine that can reduce emission of greenhouse gas is described. The construction machine includes a main body that is revolvable by revolving of a revolving part, a working device connected to one side of the main body, a hydrogen tank inside another side of the main body that stores hydrogen, and a fuel cell provided inside the main body to which the hydrogen from the hydrogen tank is supplied.

### TECHNICAL FIELD

The present invention relates to a construction machine such as a hydraulic excavator that performs excavation and loading work, and particularly relates to a construction machine that emits less greenhouse gas.

### BACKGROUND

Conventionally, vehicles that emit less greenhouse gas have been developed, and application of a fuel cell also to a backhoe of a construction machine is disclosed in JP Patent Publication No. 2010-173639 A. Furthermore, recently, automatic operation of a construction machine has also been proposed in JP Patent Publication No. 2019-65661 A and the like.

### SUMMARY

JP Patent Publication No. 2010-173639 A discloses the fuel cell in detail, but the publication does not disclose how to mount the fuel cell on the construction machine. Thus, a construction machine that emits less greenhouse gas has not been achieved.

Furthermore, in JP Patent Publication No. 2019-65661 A, because a driver's seat is provided also in the automatic operation, a layout of the construction machine is limited.

Therefore, an object of the present invention is to provide a construction machine that emits less greenhouse gas.

Furthermore, another object of the present invention is to provide a construction machine with a high degree of freedom in layout.

A construction machine according to a first implementation of the invention includes: a main body unit revolvable by revolving of a revolving part; a working device connected to one end side of the main body unit; a hydrogen tank that is provided inside another end side of the main body unit and stores hydrogen; and a fuel cell provided inside the main body unit to which the hydrogen from the hydrogen tank is supplied.

A construction machine according to a second implementation of the invention includes: a main body unit revolvable by revolving of a first revolving part; a first working device connected to one end side of the main body unit; a second working device connected to another end side of the main body unit; and a housing unit revolvable by a second revolving part different from the first revolving part.

According to the first implementation, because a construction machine is driven by a fuel cell, it is possible to achieve the construction machine that emits less greenhouse gas.

According to the second implementation, because a construction machine includes a main body unit revolvable by a first revolving part and a housing unit revolvable by a second revolving part, it is possible to provide the construction machine with a high degree of freedom in layout.

### BRIEF DESCRIPTION OF THE DRAWINGS

FIG. 1A is a schematic top view of a construction machine representing the present first embodiment, and FIG. 1B is a schematic front view of a construction machine representing the present first embodiment.

FIG. 2 is a view taken along a line A-A of FIG. 1B.

FIG. 3 is a block diagram of a main part of the present first embodiment.

FIG. 4A is a schematic top view of a construction machine representing the present second embodiment, and FIG. 4B is a schematic front view of a construction machine representing the present second embodiment.

FIG. 5 is a partial cross-sectional view of the construction machine representing the present second embodiment.

FIG. 6 is a block diagram of a main part of the present second embodiment.

FIG. 7 is a flowchart executed by a heavy machine control device of the present embodiment.

FIG. 8A is a view illustrating excavation operation when working devices are at initial positions, FIG. 8B is a view illustrating a state at the time of excavation, FIG. 8C is a view illustrating a state at the end of the excavation, and FIG. 8D is a view illustrating a state after revolving.

FIG. 9A is a view illustrating operation following the excavation operation of FIGS. 8A-8D when working devices are in a state of loading, FIG. 9B is a view illustrating when the working devices are at the initial positions, FIG. 9C is a view illustrating a state after an upper main body device is revolved, and FIG. 9D is a view illustrating a state at the time of excavation.

FIG. 10 is a schematic view of a construction machine representing the present third embodiment, in which a portion surrounded by a dotted line is illustrated as a partial cross-sectional view.

FIG. 11 is a schematic view of a construction machine representing the present fourth embodiment, in which a portion surrounded by a dotted line is illustrated as a partial cross-sectional view.

FIG. 12 is a block diagram of a main part of the present fourth embodiment.

### DETAILED DESCRIPTION

Hereinafter, a construction machine of a first embodiment of the present invention will be described in detail with reference to the accompanying drawings. Note that the present invention is not limited by the embodiments described below. In the present embodiment, the description will be continued by using a hydraulic excavator 1 as an example of the construction machine.

### First Embodiment

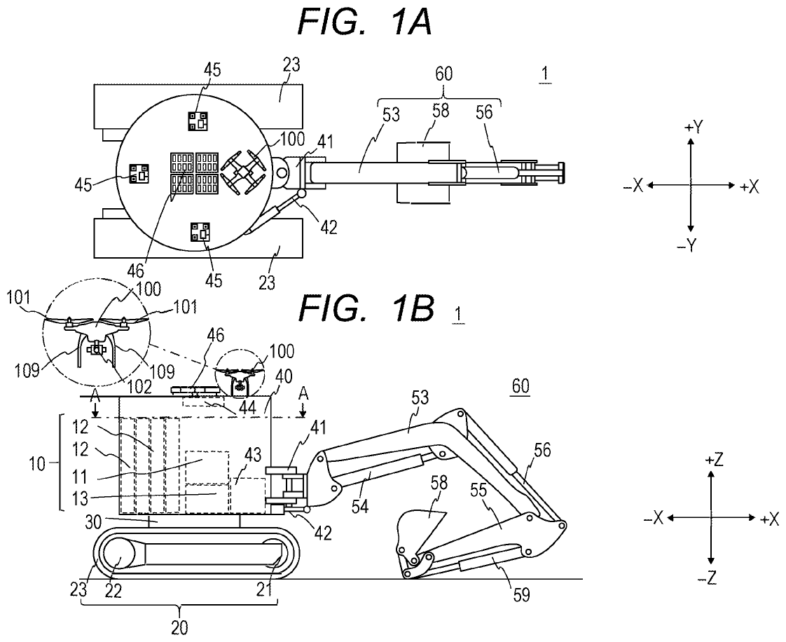

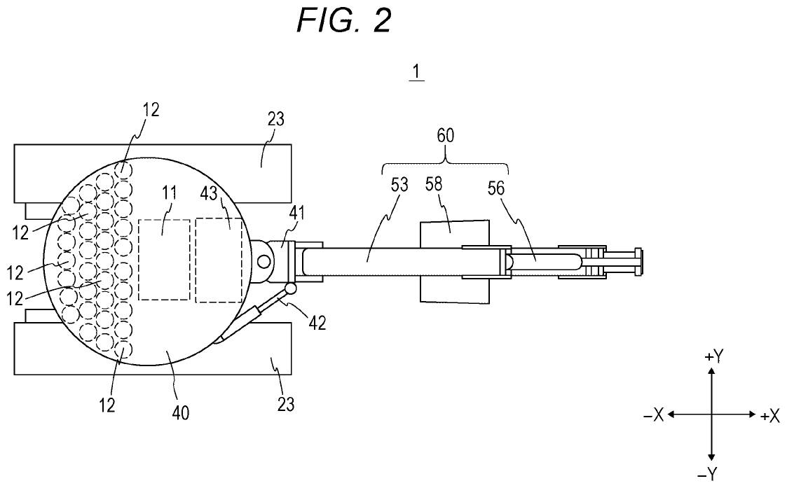

FIG. 1A is a schematic top view illustrating the hydraulic excavator 1 representing the present embodiment. FIG. 1B is a schematic front view illustrating the hydraulic excavator 1 representing the present embodiment. Furthermore, FIG. 2 is a view taken along a line A-A of FIG. 1B.

Hereinafter, a configuration of the hydraulic excavator 1 will be described with reference to FIGS. 1A, 1B, and 2. As is clear from FIGS. 1A and 1B, the hydraulic excavator 1 of the present embodiment is an automatic operation type without a driver's seat, and includes an unmanned aerial vehicle (UAV, hereinafter referred to as a drone 100). Note that the hydraulic excavator 1 may be traveled by automatic operation at a construction site and may be loaded on a trailer for transportation on a public road. Furthermore, operation of the hydraulic excavator 1 may be automatic operation or a remote operation at a remote place away from an excavation place.

The hydraulic excavator 1 of the present embodiment includes a fuel cell system 10, a traveling device 20, a revolving device 30, a main body device 40, and a working device 60. Furthermore, the hydraulic excavator 1 includes the drone 100 that can take off and land at a take-off and landing portion provided on an upper surface of the main body device 40. Note that, although one drone 100 is illustrated in FIGS. 1A and 1B, there may be a plurality of the drones 100. Furthermore, the drone 100 may be a type that flies by power, or a type that flies by a fuel cell using hydrogen.

The fuel cell system 10 includes a fuel cell 11, a hydrogen tank 12, and a storage battery 13. The fuel cell 11 is a power generator that generates electricity by electrochemical reaction of hydrogen and oxygen. The hydrogen tank 12 stores hydrogen compressed to several tens of MPa, and the hydrogen tank 12 supplies hydrogen to the fuel cell 11 via a hydrogen supply channel (not illustrated). In the present embodiment, 34 hydrogen tanks 12 are used as illustrated in FIG. 2, but the number of the hydrogen tanks 12 can be optionally set according to a size of the hydraulic excavator 1 and a size of the main body device 40. Furthermore, in FIG. 1B, the hydrogen tanks 12 are disposed upright, but the hydrogen tanks may be disposed sideways. Furthermore, although details will be described later, in the present embodiment the hydrogen tanks 12 are used as a counter mass for performing correction of an unbalanced load on the hydraulic excavator 1.

The storage battery 13 is a secondary battery that stores power generated by the fuel cell 11. The storage battery 13 can also be used as an auxiliary power supply for driving the fuel cell 11 by the stored power, and the fuel cell 11 supplies the power to various motors, the traveling device 20, the revolving device 30, and the like that constitute the hydraulic excavator 1.

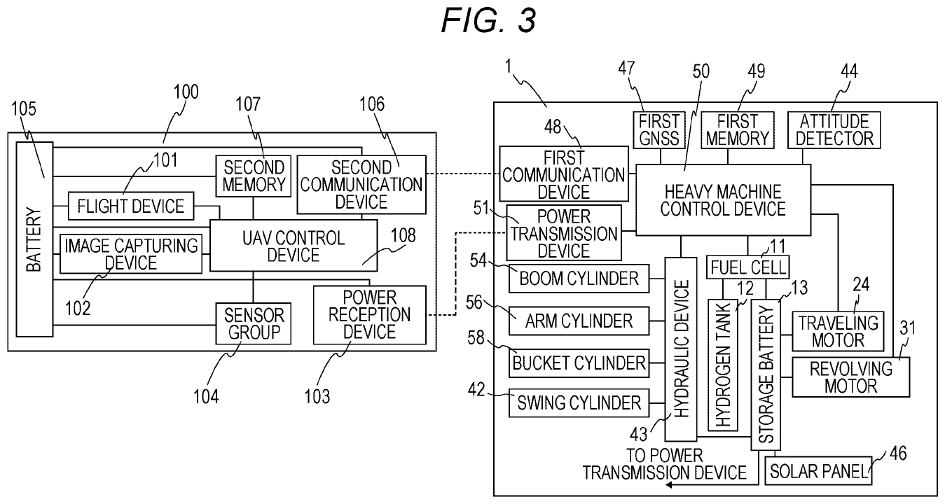

The traveling device 20 includes a pair of crawler belts 23 wound around idler wheels 21 and drive wheels 22, and a traveling motor 24 (see FIG. 3) that drives the drive wheels 22. The pair of crawler belts 23 is driven by the drive wheels 22 to cause the hydraulic excavator 1 to travel. Note that an in-wheel motor provided so as to be coaxially connected to the drive wheels 22 or hubs of the drive wheels 22 is adopted as the traveling motor 24.

The revolving device 30 is disposed in the traveling device 20 and the main body device 40. The revolving device 30 includes a bearing (not illustrated) and a revolving motor 31, and the revolving device 30 revolves the main body device 40 and the working device 60. Note that the revolving of the main body device 40 and the working device 60 by the revolving device 30 may be performed by using a hydraulic device 43 described later.

The main body device 40 has the upper surface having a flat shape and a side surface connected to the working device 60 via a swing unit 41 and a swing cylinder 42. Inside the main body device 40, the hydraulic device 43 and an attitude detector 44 are provided in addition to the fuel cell 11, the hydrogen tanks 12, and the storage battery 13 described above. Furthermore, the upper surface of the main body device 40 serves as the take-off and landing portion of the drone 100. The upper surface of the main body device 40 is provided with two-dimensional code portions 45 and a solar panel 46.

The swing unit 41 is pivotally supported such that a portion connected to the main body device 40 and a portion connected to a boom 53 are rotatable around a Z axis. The swing cylinder 42 is a hydraulic cylinder having one end connected to the main body device and the other end connected to the swing unit 41. An extending and contracting operation of the swing cylinder 42 is performed by the hydraulic device 43.

By extension and contraction of the swing cylinder 42, the working device 60 is driven in a clockwise direction or a counterclockwise direction of FIG. 1A.

The hydraulic device 43 includes a hydraulic control valve and the like, and as illustrated in FIG. 3, power from the storage battery 13 is supplied to drive the swing cylinder 42, a boom cylinder 54, an arm cylinder 56, and a bucket cylinder 59.

The attitude detector 44 is a sensor that is attached inside the main body device 40 and detects an attitude of the main body device 40. As the attitude detector 44, an inclinometer, a level, or the like can be used.

The two-dimensional code portion 45 adopts a QR® code in the present embodiment. Information in the QR® code of the present embodiment is that it is the take-off and landing portion of the drone 100. Note that the information in the QR® code may include information indicating energy to be supplied to the drone 100, such as whether the take-off and landing portion is a power supply type, a hydrogen supply type, or a type capable of supplying power and hydrogen. The QR® code is a code that is resistant to damage and dirt and has an error correction function, and thus is suitable for use at a civil engineering site. The two-dimensional code portions 45 are used to recognize a landing position by reading one of the QR® codes by an image capturing device 102 to be described later when the drone 100 lands on the take-off and landing portion.

Note that a size of the QR® codes is smaller than a size of the drone 100, and in a case where one drone 100 lands on the QR® code, an image of the QR® code cannot be captured from another drone 100. Furthermore, an interval between the plurality of two-dimensional code portions 45 is such that the drones 100 do not interfere with each other when the plurality of drones 100 lands on the take-off and landing portion. Note that a visual recognition mark may be adopted instead of the two-dimensional code portion 45. In this case, a shape of the visual recognition mark may be a circular shape, a rectangular shape, an elliptical shape, or a triangular shape, and may be a double mark or a single mark.

The solar panel 46 is a power generator, and power generated by the solar panel 46 may be stored in the storage battery 13. Furthermore, the solar panel 46 may also serve as an auxiliary power supply for driving the fuel cell 11 by the power generated by the solar panel 46. Note that an inclination mechanism may be provided on the upper surface of the main body device 40 so that the solar panel 46 can easily receive sunlight.

Furthermore, in the present embodiment, the main body device 40 includes a first global navigation satellite system (GNSS) 47 that is a global positioning system, a first communication device 48, a first memory 49, and a heavy machine control device 50 that controls the entire hydraulic excavator 1. The first GNSS 47 measures a position of the hydraulic excavator 1 by using an artificial satellite.

The first communication device 48 is a wireless communication unit that accesses a second communication device 106 to be described later or a wide area network such as the Internet. In the present embodiment, the first communication device 48 communicates flight paths of the plurality of drones 100 to the second communication device 106 on the basis of a position of the hydraulic excavator 1 detected by the first GNSS 47.

The first memory 49 is a nonvolatile memory (for example, a flash memory), and stores various types of data and programs for driving the hydraulic excavator 1 and various types of data and programs for automatically operating the hydraulic excavator 1. Furthermore, the first memory 49 stores data related to flight paths of the plurality of drones 100.

The heavy machine control device 50 is a control device that includes a central processing unit (CPU) and controls the entire hydraulic excavator 1, and controls, for example, excavation operation and revolving operation of the working device 60, and flight operation of the drone 100. Furthermore, on the upper surface of the main body device 40, a power transmission device 51 that supplies power to a power reception device 103 to be described later on a side of the drone 100 is provided.

The power transmission device 51 adopts wireless power supply in the present embodiment. The wireless power supply supplies power to the power reception device 103 in a non-contact manner, and a magnetic field resonance system, an electromagnetic induction system, and the like are known. The power transmission device 51 of the present embodiment includes a power supply, a control circuit, and a power transmission coil. The power transmission coil is preferably provided in the take-off and landing portion.

Note that a contact-type power supply system may be adopted instead of the wireless power supply. In this case, a metal contact may be provided on each of the power transmission device 51 and the power reception device 103, and the contacts may be mechanically connected to each other for power supply. For example, a contact having a recess shape may be provided on the take-off and landing portion, and a contact having a projection shape may be provided on the side of the drone 100. One contact having the recess shape and one contact having the projection shape may be provided, or a plurality of the contacts having the recess shape and a plurality of the contacts having the projection shape may be provided.

The working device 60 is connected to the main body device 40 via the swing unit 41 and the swing cylinder 42. The working device 60 includes the boom 53, the boom cylinder 54, an arm 55, the arm cylinder 56, a bucket 58, and the bucket cylinder 59.

The boom 53 is a chevron-shaped part connected to the main body device 40 via the swing unit 41. The boom 53 is rotated by the boom cylinder 54.

The arm 55 is connected to a distal end of the boom 53. The arm 55 is rotated by the arm cylinder 56.

The bucket 58 is connected to a distal end of the arm 55. The bucket is rotated by the bucket cylinder 59. Note that, instead of the bucket 58, a breaker or the like can be attached to the distal end of the arm 55.

In the present embodiment, the boom cylinder 54, the arm cylinder 56, and the bucket cylinder 59 are hydraulic cylinders that extend and contract by hydraulic pressure. Furthermore, the extending and contracting operation of the boom cylinder 54, the arm cylinder 56, and the bucket cylinder 59 are performed by the hydraulic device 43.

The drone 100 of the present embodiment includes flight devices 101, the image capturing device 102, the power reception device 103, a sensor group 104, a battery 105, the second communication device 106, a second memory 107, and a UAV control device 108.

The flight device 101 includes a motor (not illustrated) and a plurality of propellers, and the flight device 101 floats the drone 100 in the air and generates thrust to move the drone 100 in the air. Note that, as described above, the number of drones 100 that land on the take-off and landing portion can be optionally set. Furthermore, the configuration of each drone 100 may be the same, or a part thereof may be changed. Moreover, the sizes of the respective drones 100 may be the same or different.

The image capturing device 102 is a digital camera that includes a lens, an imaging element, an image processing engine, and the like, and captures a moving image and a still image. In the present embodiment, the image capturing device 102 performs surveying, captures an image of an excavated portion, and captures images of the two-dimensional code portions 45. Note that, when the power transmission coil or the contact of the power transmission device 51 is provided in the two-dimensional code portion 45, the battery 105 can be charged via the power reception device 103 promptly after the drone 100 lands on the take-off and landing portion.

In an enlarged view surrounded by an alternate long and short dash line in FIG. 1, the lens of the image capturing device 102 is attached to a side surface (front surface) of the drone 100, but the lens of the image capturing device 102 may be attached to a lower surface of the drone 100, or a plurality of lenses may be provided in the drone 100. Furthermore, a moving mechanism that moves the lens attached to the side surface toward the lower surface may be provided. Furthermore, a mechanism that rotates the image capturing device 102 around the Z axis may be provided to position the lens of the image capturing device 102 at an optional position around the Z axis. Furthermore, in a case where the four drones 100 land on the take-off and landing portion, when the respective lenses are positioned in a −X direction, a +X direction, a −Y direction, and a +Y direction, images close to images visually recognized by an operator from a driver's seat of a conventional hydraulic excavator can be captured from the plurality of directions.

Note that an omnidirectional camera (360-degree camera) may be used as the image capturing device 102, or a three-dimensional scanner may be used instead of the image capturing device 102.

The power reception device 103 includes power reception coils, charging circuits, and the like provided in leg portions 109 of the drone 100. The power reception device 103 charges the battery 105 with power from the power transmission device 51.

The battery 105 is a secondary battery connected to the power reception device 103, and a lithium-ion secondary battery, a lithium polymer secondary battery, or the like can be used as the battery 105, but the battery 105 is not limited thereto. The battery 105 can supply power to the flight devices 101, the image capturing device 102, the second communication device 106, the second memory 107, and the UAV control device 108.

The sensor group 104 is a GNSS, an infrared sensor for avoiding collision between the drone 100 and another device (for example, the working device 60), an atmospheric pressure sensor that measures an altitude, a magnetic sensor that detects an azimuth, a gyro sensor that detects an attitude of the drone 100, an acceleration sensor that detects acceleration acting on the drone 100, and the like.

The second communication device 106 includes a wireless communication unit. The second communication device 106 accesses a wide area network such as the Internet and communicates with the first communication device 48. In the present embodiment, the second communication device 106 transmits image data captured by the image capturing device 102 and a detection result detected by the sensor group 104 to a second communication device 92. The second communication device 106 also transmits a flight command from the first communication device 48 to the UAV control device 108.

The second memory 107 is a nonvolatile memory (for example, a flash memory) that stores various types of data and programs for flying the drone 100, and that stores image data captured by the image capturing device 102, a detection result detected by the sensor group 104, and the like.

The UAV control device 108 includes a CPU, an attitude control circuit, a flight control circuit, and the like, and controls the entire drone 100. Furthermore, the UAV control device 108 determines timing of charging at the take-off and landing portion from a remaining amount of the battery 105, and the UAV control device 108 controls an image capturing position, an angle of view, a frame rate, and the like of the image capturing device 102.

In the hydraulic excavator 1 of the present embodiment configured as described above, the drone 100 can survey an excavation area prior to excavation of the working device 60 and can capture an image from the sky and capture an image of the bucket near the bucket 58 during the excavation of the working device 60, so that the excavation can be performed even when a worker is not in the excavation area. Furthermore, when the drone 100 performs image capturing at the take-off and landing portion, image capturing can be performed from substantially the same position as from a driver's seat of a conventional hydraulic excavator.

Furthermore, by using the plurality of drones 100, when a first drone 100 is flying, a second drone 100 can be charged at the take-off and landing portion. In this way, the first drone 100 and the second drone 100 can be alternately flown. Note that the number of drones 100 may be three or more.

Furthermore, when the working device 60 performs excavation, an unbalanced load acts on the main body device 40 in the +X direction of FIGS. 1A and 1B. However, in the present embodiment, because the plurality of hydrogen tanks 12 is provided on an opposite side (−X direction of FIGS. 1A and 1B) of a side to which the working device 60 is connected, the unbalanced load acting on the main body device 40 when the working device 60 performs the excavation can be offset by loads of the plurality of hydrogen tanks 12. The unbalanced load of the working device 60 acting on the main body device 40 depends on a volume of the bucket 58. Thus, according to the volume of the bucket 58, a weight of the counter mass is required to be approximately 1.5 tons to 4 tons. When the hydrogen tank 12 is made of iron, because the weight is about 50 kg in a state where hydrogen is not filled, the total weight of the 34 hydrogen tanks 12 is 1700 kg. In a case where the total weight of the hydrogen tanks 12 is not enough, it is sufficient to provide a counter mass as a mass body separately in the −X direction of the main body device 40.

Note that a hydrogen absorbing alloy may be used as the hydrogen tank 12. The hydrogen absorbing alloy is an alloy having both hydrogen absorbing capability and hydrogen releasing capability by alloying Ti, Zr, Pd, and Mg having excellent hydrogen absorbing capability and Fe, Co, and Ni having high hydrogen releasing capability. In a case where hydrogen is stored in the hydrogen absorbing alloy, it is not necessary to store hydrogen at high pressure, and the stored hydrogen is easy to handle. Furthermore, the heavy weight, which is conventionally considered a disadvantage, is also an advantage when used as the counter mass. Because the weight of the hydrogen tank 12 using the hydrogen absorbing alloy is about 125 kg, the total weight of the 34 hydrogen tanks 12 is 4250 kg, which is almost satisfactory as the weight of the counter mass. Furthermore, as the hydrogen tanks 12, both one that stores hydrogen compressed to several tens of MPa and one that is the hydrogen absorbing alloy may be used. In this case, by providing the heavy tank of the hydrogen absorbing alloy outside (side in the −X direction) the tank that stores hydrogen compressed to several tens of MPa, a distance from the main body device 40 can be increased, so that the tank of the hydrogen absorbing alloy can be effectively used as the counter mass.

Furthermore, because the hydraulic excavator 1 of the present embodiment uses the fuel cell 11 and the solar panel 46, it is possible to achieve a construction machine that emits less greenhouse gas. In the present embodiment, because a space without a driver's seat is used, a large number of hydrogen tanks 12 can be housed. Thus, the hydraulic excavator 1 can be driven by the fuel cell 11 even at a civil engineering site in a mountain where it is difficult to supply hydrogen. Note that, although a heating device is required when hydrogen is extracted from the hydrogen absorbing alloy, it is sufficient to heat the hydrogen absorbing alloy by using exhaust heat of the fuel cell 11. In this case, it is sufficient to provide the fuel cell 11 in the vicinity of the hydrogen absorbing alloy.

### Second Embodiment

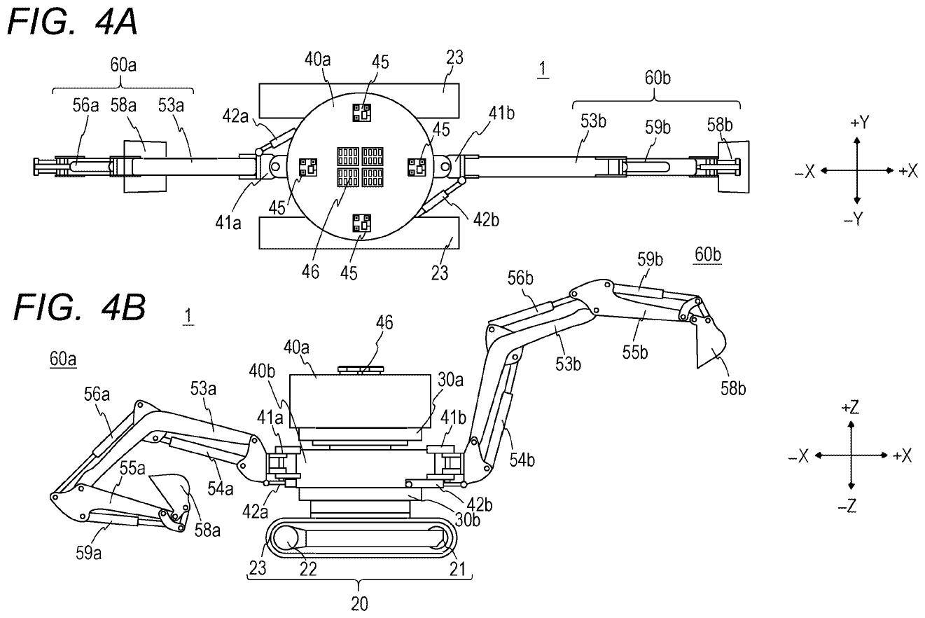

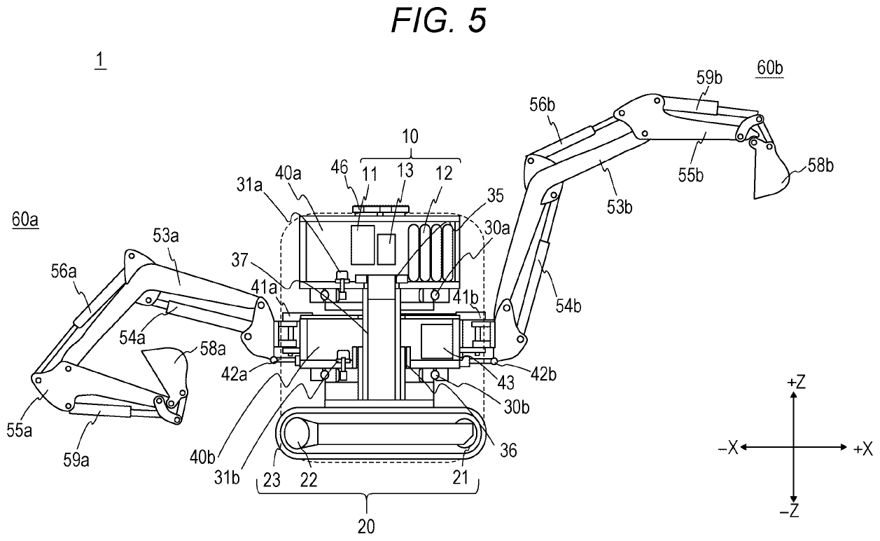

Hereinafter, a second embodiment will be described with reference to FIGS. 4A, 4B, 5, and 6, but the same configurations as those of the first embodiment are denoted by the same reference signs, and description thereof will be omitted or simplified. Note that illustration of a drone 100 is omitted in FIGS. 4A, 4B, and 5.

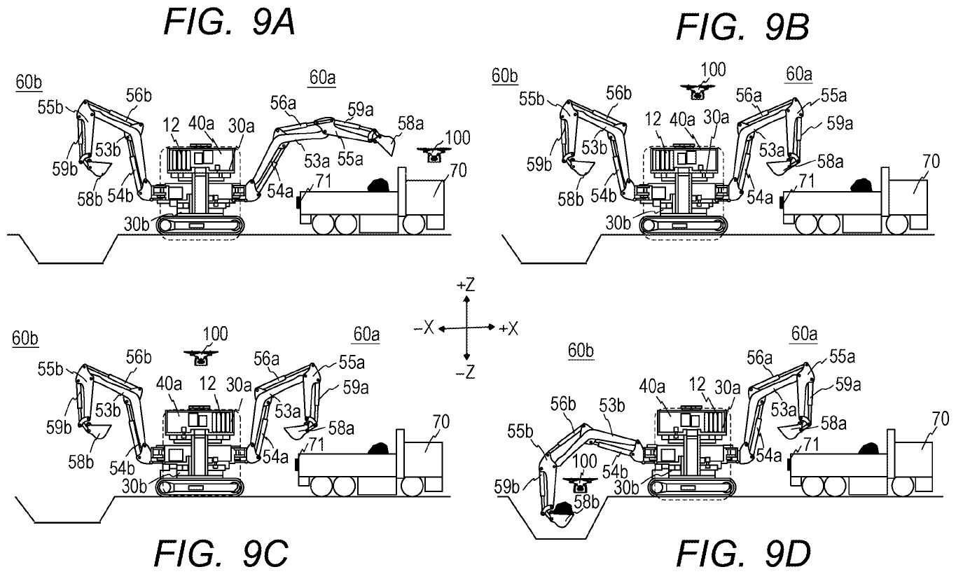

FIG. 4A is a schematic top view of a hydraulic excavator 1 representing an example of a construction machine representing the present second embodiment. FIG. 4B is a schematic front view of a hydraulic excavator 1 representing an example of a construction machine representing the present second embodiment. Furthermore, FIG. 5 illustrates a portion surrounded by a dotted line of the hydraulic excavator 1 representing the present second embodiment as a partial cross-sectional view, and FIG. 6 is a block diagram of a main part of the present second embodiment. Hereinafter, the present second embodiment will be described with reference to FIGS. 4A, 4B, 5, and 6.

In the hydraulic excavator 1 of the present second embodiment, a revolving device and a main body device 40 are divided into two, and there are two working devices 60. The two revolving devices 30 will be described as an upper revolving device 30a and a lower revolving device 30b. Furthermore, the revolving motor 31 of the first embodiment is divided into two, that is, an upper revolving motor 31a and a lower revolving motor 31b. Similarly, the two main body devices 40 will be described as an upper main body device 40a and a lower main body device 40b. Furthermore, because configurations of the two working devices 60 are the same as those of the first embodiment, one is defined as a working device and the other is defined as a working device 60b, and each element constituting the working devices 60a and 60b is also denoted by a reference sign added with a or b in the end.

The upper main body device 40a is revolvable by the upper revolving device 30a having a bearing. The upper main body device 40a also functions as a housing unit and houses a fuel cell 11, a plurality of hydrogen tanks 12, a storage battery 13, a part of the upper revolving motor 31a for revolving the upper main body device 40a, and the like.

Furthermore, an opening unit is formed in a lower center of the upper main body device 40a, and an upper slip ring 35 constituting a part of a slip ring mechanism to be described later is engaged with the opening unit. The upper slip ring 35 has an opening, and wiring or the like that supplies power to the lower revolving motor 31b and a traveling motor 24 is routed through the opening. A part of the upper slip ring 35 revolves with the revolving of the upper main body device 40a.

The slip ring mechanism includes, in addition to the upper slip ring 35, a lower slip ring 36, and a fixing unit 37 connected to a non-revolving portion of the upper slip ring 35 and a non-revolving portion of the lower slip ring 36. The lower slip ring 36 is provided in the lower main body device 40b and supports the fixing unit 37 from the outside. The fixing unit 37 is provided so as to penetrate the lower revolving device 30b and has an opening for routing the wiring from the upper slip ring 35. Thus, even when the upper main body device 40a and the lower main body device 40b revolve, because the wiring is routed by the slip ring mechanism, the wiring is not entangled or disconnected. Note that a pipe for liquid (hydraulic pressure or water), gas, or the like may be routed by using the slip ring mechanism.

The lower main body device 40b is revolvable by the lower revolving device 30b having a bearing. To the lower main body device 40b, the working device 60a is connected on a side in the −X direction via a swing unit 41a and a swing cylinder 42a, and the working device 60b is connected on a side in the +X direction via a swing unit 41b and a swing cylinder 42b. By connecting the working device 60a and the working device 60b to the lower main body device 40b, it is possible to suppress an increase in the center of gravity of the hydraulic excavator 1.

Furthermore, the lower main body device 40b houses a part of the lower revolving motor 31b, the lower slip ring 36, a hydraulic device 43, and the like, and has an opening for penetrating the fixing unit 37, which is formed near a central portion. Note that, although illustration is omitted in FIG. 5, an attitude detector 44 is preferably provided in the upper main body device 40a functioning as a counterweight. Note that, to house the fuel cell 11, the plurality of hydrogen tanks 12, the storage battery 13, and the like in the upper main body device 40a, it is sufficient that a volume of the upper main body device 40a is about 8 m³ to 10 m³. Thus, as an example of a size of the upper main body device 40a, when the upper main body device 40a has a cylindrical shape, it is sufficient to have a radius of 1.5 m and a height of about 1.2 m. Note that the upper main body device 40a is not limited to the cylindrical shape and may have an optional shape.

Description of Flowchart

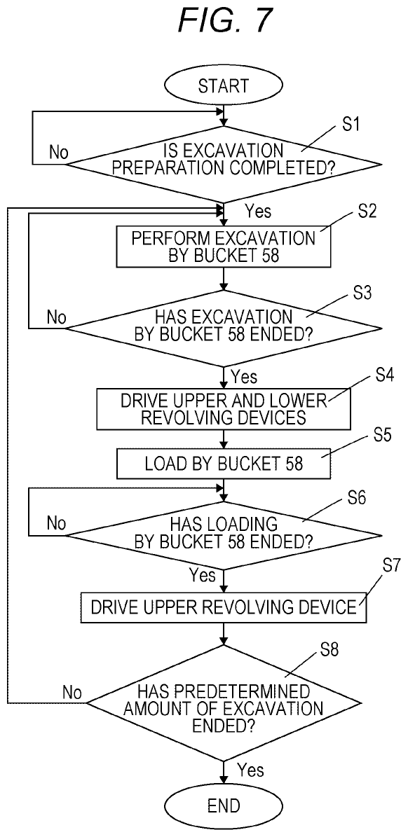

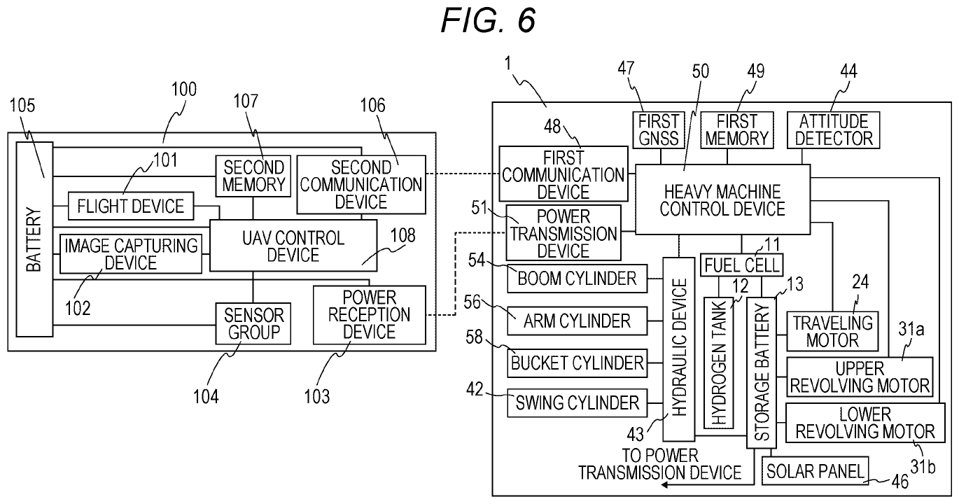

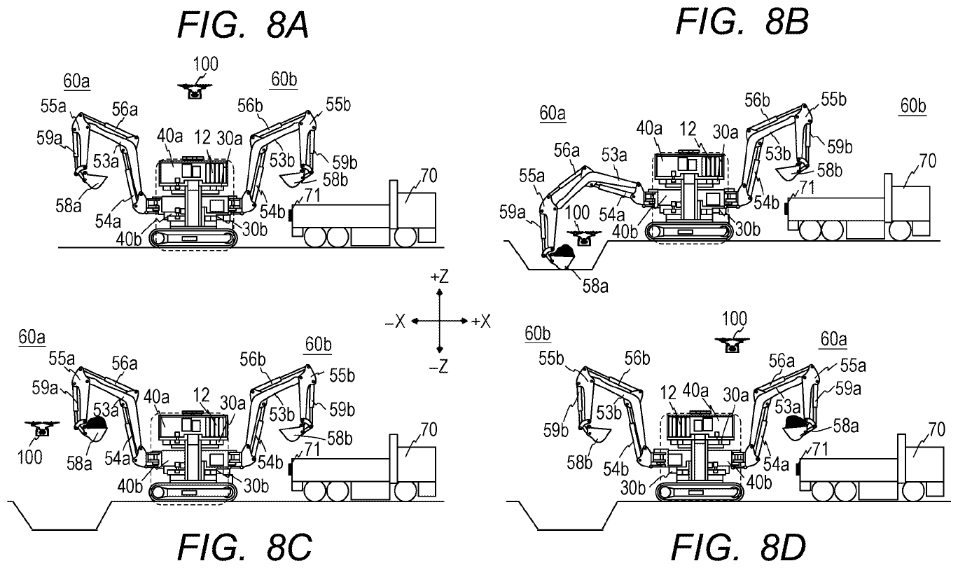

FIG. 7 is a flowchart executed by a heavy machine control device 50 of the present embodiment. Furthermore, FIG. 8A is a view illustrating excavation operation when the working devices 60 are at initial positions, FIG. 8B is a view illustrating a state at the time of excavation, FIG. 8C is a view illustrating a state at the end of the excavation, and FIG. 8D is a view illustrating a state after revolving. Furthermore, FIG. 9A is a view illustrating operation following the excavation operation of FIGS. 8A-8D when the working devices 60 are in a state of loading, FIG. 9B is a view illustrating when the working devices 60 are at the initial positions, FIG. 9C is a view illustrating a state after the upper main body device 40a is revolved, and FIG. 9D is a view illustrating a state at the time of excavation.

Hereinafter, the flowchart of FIG. 7 will be described with reference to FIGS. 8A—9D. Note that, in FIGS. 8A-9D, portions surrounded by dotted lines are illustrated as partial cross-sectional views as in FIG. 5. Furthermore, in the present embodiment, the initial positions refer to when the two working devices 60 are at positions where an unbalanced load is unlikely to be generated (that is, positions where portions extending in the X direction are small). Note that, in the flowchart of FIG. 7, a part thereof may be performed by, for example, a worker in a remote place away from a civil engineering site.

The heavy machine control device 50 determines whether excavation preparation by the hydraulic excavator 1 is completed or not (Step S1). When the hydraulic excavator 1 arrives at an excavation place and can perform excavation and a dump truck 70 arrives at a loading place, as illustrated in FIG. 8A, the heavy machine control device 50 proceeds to Step S2 on the assumption that the excavation preparation is completed, and repeats Step S1 otherwise. Here, it is assumed that the heavy machine control device 50 proceeds to Step S2 assuming that the excavation preparation is completed. Note that, at a rear part of the dump truck 70, a two-dimensional code portion 71 indicating a loading amount of the dump truck 70 is provided. By an image capturing device 102 of the drone 100 capturing an image of the two-dimensional code portion 71, the heavy machine control device 50 can recognize the loading amount of the dump truck 70.

As illustrated in FIG. 8B, the heavy machine control device 50 performs excavation by a bucket 58a constituting a part of the first working device (Step S2). When performing the excavation by the bucket 58a, the heavy machine control device 50 can confirm an excavation situation by flying the drone 100 in the vicinity of the bucket 58a and causing the image capturing device 102 to capture an image of the excavation operation by the bucket 58a. In the present embodiment, because the working device 60a and the working device 60b have the same configuration, the weights thereof are also assumed to be the same. However, as illustrated in FIG. 8B, when the working device 60a extends in the −X direction and an excavation object is housed in the bucket 58a, an unbalanced load in the −X direction acts on the hydraulic excavator 1. Therefore, in the present embodiment, the plurality of hydrogen tanks 12 housed in the upper main body device 40a is positioned in the +X direction to correct the unbalanced load. Note that, in a case where the unbalanced load cannot be sufficiently corrected by the weight of the plurality of hydrogen tanks 12, the heavy machine control device 50 may drive the working device 60b to extend in the +X direction from the initial position. Furthermore, the upper main body device 40a may house a mass body different from the plurality of hydrogen tanks 12 as a counter mass.

The heavy machine control device 50 determines whether the excavation by the bucket 58a has ended or not (Step S3). In the case of determining that a predetermined amount of the excavation object is housed in the bucket 58a by the image capturing by the image capturing device 102 of the drone 100, the heavy machine control device 50 determines that the excavation by the bucket 58a has ended. Alternatively, a worker in a remote place may determine whether the excavation by the bucket 58a has ended based an image capturing result of the image capturing device 102 of the drone 100 or not. Furthermore, a gravimeter may be provided in the bucket 58a, and the heavy machine control device 50 may determine whether a predetermined amount of the excavation object is housed in the bucket 58a based on a measurement result of the gravimeter or not. Here, it is assumed that the heavy machine control device 50 proceeds to Step S4 assuming that the excavation by the bucket 58a has ended. Note that, when determining that the excavation by the bucket 58a has ended, the heavy machine control device 50 moves the working device 60a to the initial position as illustrated in FIG. 8C. This is to reduce an unbalanced load acting on the lower main body device 40b by revolving by the working device 60a in Step S4 and to perform the revolving safely.

The heavy machine control device 50 revolves the upper main body device 40a by 180 degrees by the upper revolving motor 31a, and the heavy machine control device 50 revolves the lower main body device 40b by 180 degrees by the lower revolving motor 31b (Step S4). The lower main body device 40b is revolved to load the excavation object housed in the bucket 58a into the dump truck 70 and to move a bucket 58b constituting a part of the second working device to an excavation position. The upper main body device 40a is revolved to correct the unbalanced load acting on the hydraulic excavator 1 due to the revolving of the lower main body device 40b. With this configuration, it is possible to prevent the hydraulic excavator 1 from floating or falling when the lower main body device 40b is revolved. Note that, to reduce the unbalanced load acting on the hydraulic excavator 1, it is preferable that the upper main body device 40a and the lower main body device 40b are revolved in the same direction. Specifically, in a case where the upper main body device 40a is revolved in the clockwise direction, it is sufficient that the heavy machine control device also revolves the lower main body device 40b in the clockwise direction. FIG. 8D is a view illustrating a state where the revolving in Step S4 is performed, and the bucket 58a is positioned on the side in the +X direction, and the bucket 58b and the hydrogen tank 12 are located on the side in the −X direction.

As illustrated in FIG. 9A, the heavy machine control device 50 drives and controls the working device 60a to load the excavation object housed in the bucket 58a into the dump truck 70 (Step S5). At this time, the heavy machine control device 50 can confirm the loading work by flying the drone 100 in the vicinity of the bucket 58a and causing the image capturing device 102 to capture an image of the loading operation by the bucket 58a. Note that, in Step S5, the heavy machine control device 50 may finely adjust the position of the working device 60a by the swing unit 41a and the swing cylinder 42a.

The heavy machine control device 50 determines whether the loading work by the bucket 58a has ended on the basis of the image capturing by the image capturing device 102 or a measurement result of the gravimeter or not (Step S6). Note that the determination in Step S6 may be made by a worker in a remote place. When the loading work has ended, the heavy machine control device 50 moves the working device 60a to the initial position as illustrated in FIG. 9B.

When determining that the loading work by the bucket 58a has ended, the heavy machine control device 50 revolves the upper main body device 40a by 180 degrees to prepare for excavation work by the working device 60b (Step S7). Because the hydrogen tanks 12 are positioned on the side in the +X direction as illustrated in FIG. 9C by the revolving of the upper main body device 40a by 180 degrees, it is possible to correct the unbalanced load acting on the hydraulic excavator 1 by the excavation operation of the working device 60b. Note that, by performing the movement of the working device 60a to the initial position illustrated in FIG. 9B and the revolving of the upper main body device 40a almost at the same time, the excavation work by the working device 60b can be started quickly. Moreover, when the movement of the working device 60a to the initial position and the revolving of the upper main body device 40a are performed, the working device 60b may be moved from the initial position to the excavation position. With this configuration, the excavation work by the working device 60b can be started more quickly. In this way, in a case where the working device 60b is moved from the initial position to the excavation position, since the excavation object is not housed in the bucket 58b, a large unbalanced load does not act on the hydraulic excavator 1. Note that the correction of the unbalanced load on the hydraulic excavator 1 by the revolving of the upper main body device 40a is also possible in a case where an unexpected load acts on the hydraulic excavator 1. In such a case, it is sufficient that the heavy machine control device 50 revolves the upper main body device 40a on the basis of output of the attitude detector 44.

The heavy machine control device 50 determines whether a predetermined amount of excavation has ended or not (Step S8). Here, the heavy machine control device 50 returns to Step S2, assuming that the predetermined amount of excavation has not yet ended. Then, the heavy machine control device 50 performs a series of the excavation operation by the working device 60b, and thereafter, alternately repeats excavation by the working device 60a and excavation by the working device 60b until the predetermined amount of excavation is reached. Note that the heavy machine control device 50 may make the determination in Step S8 based on the loading amount of the dump truck 70, which is information in the two-dimensional code portion 71. Note that a program for executing the flowchart of FIG. 7 is stored in a first memory 49.

As described above, according to the present second embodiment, because the excavation by the working device 60a and the excavation by the working device 60b are alternately repeated, a work period of excavation work can be shortened. Note that, although one drone 100 is illustrated in FIGS. 8A-9D, the flowchart of FIG. 7 may be executed by a plurality of the drones 100. Furthermore, the image capturing by the image capturing device 102 of the drone 100 may be performed not only during the flight but also during landing on a take-off and landing portion of the upper main body device 40a. An image captured by the image capturing device 102 from the take-off and landing portion of the upper main body device 40a can be used as an image visually recognized by a worker from a conventional driver's seat.

Note that, in a case where the drone 100 is flown in the vicinity of the bucket 58, a UAV control device 108 can avoid collision between the bucket 58 and the drone 100 by recognizing the bucket 58 by an infrared sensor of a sensor group 104.

Furthermore, the heavy machine control device 50 may perform image capturing by the image capturing device 102 of the drone 100 when a failure occurs in the hydraulic excavator 1 or to determine whether or not maintenance is necessary.

Furthermore, in a civil engineering site, the two-dimensional code portion 71 may become dirty and unrecognizable. In such a case, the two-dimensional code portion 71 may be cleaned by using water generated by the fuel cell 11 using reaction between hydrogen and oxygen.

### Third Embodiment

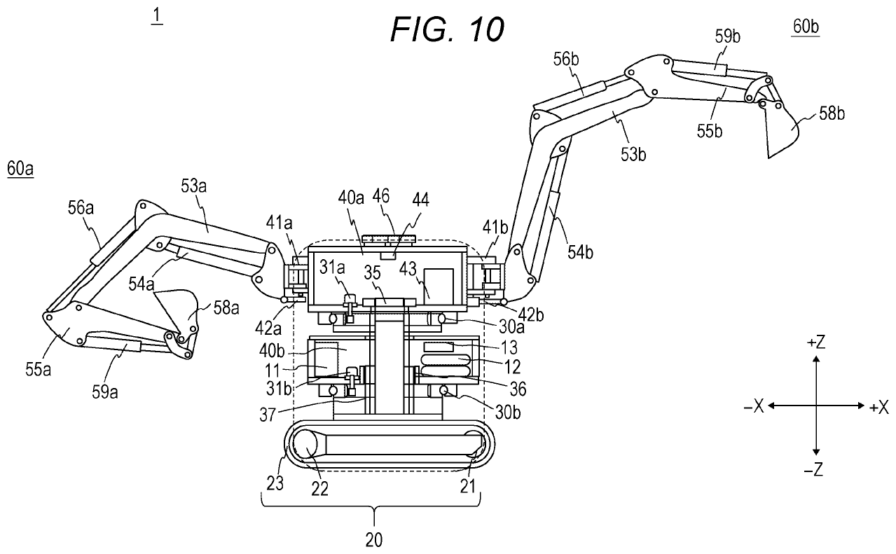

FIG. 10 is a schematic view of a hydraulic excavator 1 representing an example of a construction machine representing the present third embodiment, in which a portion surrounded by a dotted line is illustrated as a partial cross-sectional view. Note that illustration of a drone 100 is omitted in FIG. 10. Hereinafter, the third embodiment will be described with reference to FIG. 10, but the same configurations as those of the first and second embodiments are denoted by the same reference signs, and description thereof will be omitted or simplified.

The present third embodiment is different from the second embodiment in that a lower main body device 40b is a housing unit, and two working devices 60 are connected to an upper main body device 40a via swing units 41 and swing cylinders 42. Thus, a hydraulic device 43 that supplies hydraulic pressure to the two working devices 60 is provided in the upper main body device 40a.

The lower main body device 40b houses a fuel cell 11, a plurality of hydrogen tanks 12, a storage battery 13, a part of a lower revolving motor 31b, a lower slip ring 36, and the like. In the present embodiment, the lower main body device 40b houses the plurality of hydrogen tanks 12 in a laid state, but the plurality of hydrogen tanks 12 may be housed in an upright state by increasing a dimension in the Z direction.

In the present embodiment, the lower main body device 40b housing the plurality of hydrogen tanks 12 as a mass body functions as a counter mass and moves (revolves) to correct an unbalanced load acting on the hydraulic excavator 1. In this way, also in the present embodiment, it is possible to correct the unbalanced load acting on the hydraulic excavator 1 when one working device 60 performs excavation work.

### Fourth Embodiment

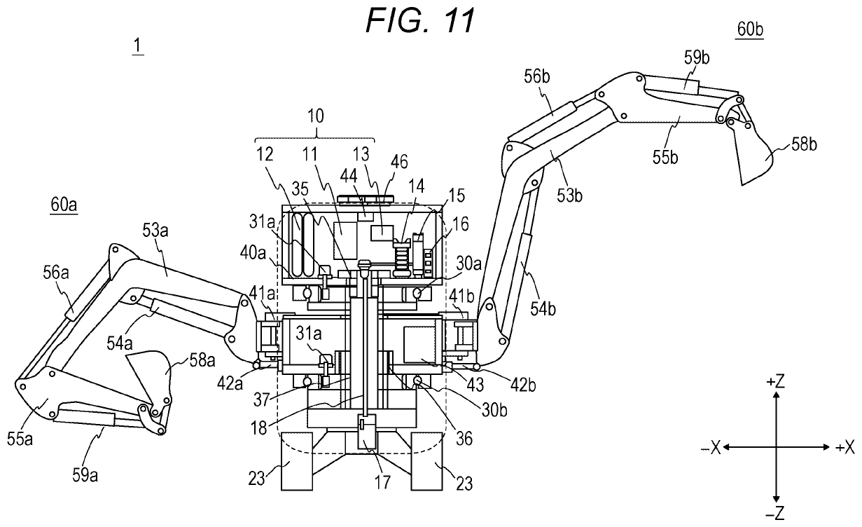

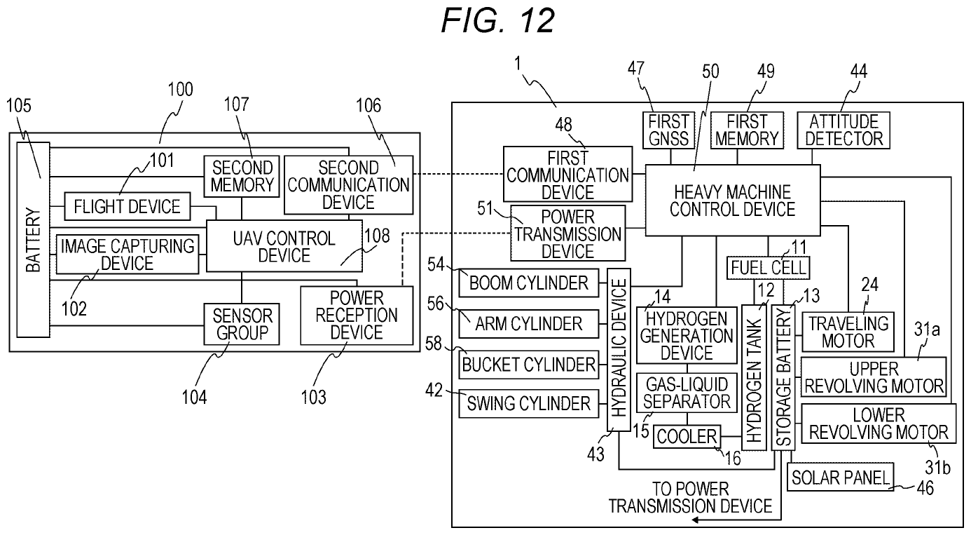

FIG. 11 is a schematic view of a hydraulic excavator 1 representing an example of a construction machine representing the present fourth embodiment, in which a portion surrounded by a dotted line is illustrated as a partial cross-sectional view. Furthermore, illustration of a drone 100 is omitted in FIG. 11. FIG. 12 is a block diagram of a main part of the present fourth embodiment. Hereinafter, the fourth embodiment will be described with reference to FIGS. 11 and 12, but the same configurations as those of the first to third embodiments are denoted by the same reference signs, and description thereof will be omitted or simplified.

In the present fourth embodiment, in addition to a fuel cell system 10 and the like, a hydrogen production device that supplies hydrogen to hydrogen tanks 12 is housed in an upper main body device 40a. The hydrogen production device includes a hydrogen generation device 14, a gas-liquid separator 15, and a cooler 16. Furthermore, a tank 17 that stores water for producing hydrogen is provided at a lower part of the hydraulic excavator 1. The water stored in the tank 17 is supplied to the hydrogen generation device 14 via a pipe 18 by a pump (not illustrated). Note that the pipe 18 is provided so as to pass through the respective openings of a lower slip ring 36, a fixing unit 37, and an upper slip ring 35.

The hydrogen generation device 14 is a high-pressure water electrolysis device that produces oxygen and high-pressure hydrogen of several tens of MPa by electrolysis of water. In the high-pressure water electrolysis device, for example, as disclosed in JP 2015-175037 A, a plurality of water decomposition cells is laminated along the Z direction. The gas-liquid separator 15 removes water contained in high-pressure hydrogen generated by the hydrogen generation device 14. Furthermore, the cooler 16 cools hydrogen that has passed through the gas-liquid separator 15. The hydrogen cooled by the cooler 16 is stored in the plurality of hydrogen tanks 12 through a pipe (not illustrated) and a valve (not illustrated).

To house the hydrogen production device described above in addition to the fuel cell system 10 and the like in the upper main body device 40a, it is sufficient that a volume of the upper main body device 40a is about 12 m³ to 16 m³. Thus, as an example of a size of the upper main body device 40a, when the upper main body device 40a has a cylindrical shape, it is sufficient to have a radius of 1.6 m and a height of about 1.6 m. Note that the upper main body device 40a is not limited to the cylindrical shape and may have any optional shape. Furthermore, the volume of the upper main body device 40a may be set according to the number of hydrogen tanks 12 to be housed.

According to the present embodiment, because hydrogen can be produced when water is available, the hydraulic excavator 1 can be driven by a fuel cell 11 even at a civil engineering site in a mountain where it is difficult to supply hydrogen. Note that the hydrogen production device may be provided at the civil engineering site, not in the hydraulic excavator 1 or in addition to the hydraulic excavator 1. With this configuration, also in the hydraulic excavators 1 of the first to third embodiments, it is easy to supply hydrogen to the hydrogen tanks 12.

Note that, in the present embodiment, a high-pressure water electrolysis system is used as the hydrogen production device, but another system may be used. Furthermore, the hydrogen production device of the present embodiment may be used in the first to third embodiments. In the case of being used in the third embodiment, it is sufficient to provide the hydrogen production device in the lower main body device 40b.

As described above in detail, since the two working devices 60 are provided in the second to fourth embodiments, it is possible to perform excavation and loading (dumping) almost at the same time, and thus, it is possible to achieve the hydraulic excavator 1 with good workability. Furthermore, since surveying, confirmation of an excavation situation, and the like are performed by the plurality of drones 100 in the first to fourth embodiments, a surveying time and a confirmation time of the excavation situation can be shortened. Furthermore, even in a case where the remaining amount of the battery 105 of the flying drone 100 decreases, the drone 100 that is not flying is charging, and thus, it is possible to promptly replace the drone 100 to be flown. With this configuration, it is not necessary to substantially consider limitation of a flight time of the drone 100.

Furthermore, according to the first to fourth embodiments, since the drone 100 assists the hydraulic excavator 1, automated construction work can be efficiently implemented.

The embodiments described above are merely examples for describing the present invention, and various changes can be made without departing from the gist of the present invention. For example, when an infrared camera is used as the image capturing device 102, a series of work such as excavation and loading (dumping) can be performed even at night, and a work period can be shortened. Instead of a first bucket, a breaker, a fork, a ripper, or a lifter may be attached to the arm 55.

The following is a list of reference signs used in this specification and in the drawings.
1 Hydraulic excavator
10 Fuel cell system
20 Traveling device
30 Revolving device
30a Upper revolving device
30b Lower revolving device
40 Main body device
40a Upper main body device
40b Lower main body device
43 Hydraulic device
50 Heavy machine control device
51 Power transmission device
60 Working device
100 Drone
102 Image capturing device
103 Power reception device

1. A construction machine comprising:
a main body unit revolvable by revolving of a revolving part;
a working device connected to one end side of the main body unit;
a hydrogen tank that is provided inside another end side of the main body unit and stores hydrogen; and
a fuel cell provided inside the main body unit and to which the hydrogen from the hydrogen tank is supplied.

2. The construction machine according to claim 1, wherein a take-off and landing portion at which an unmanned flying object is capable of taking off and landing is provided in the main body unit.

3. The construction machine according to claim 2, wherein a part of a power supply unit that supplies power to the unmanned flying object is provided in the take-off and landing portion.

4. The construction machine according to claim 2, wherein a two-dimensional code portion in which a two-dimensional code is formed is provided in the take-off and landing portion.

5. The construction machine according to claim 1, wherein a solar panel that generates power is provided in the main body unit.

6. The construction machine according to claim 1, wherein the hydrogen tank includes a hydrogen absorbing alloy.

7. The construction machine according to claim 1, wherein the main body unit includes a hydrogen production device.

8. A construction machine comprising:
a main body unit revolvable by revolving of a first revolving part;
a first working device connected to one end side of the main body unit;
a second working device connected to another end side of the main body unit; and
a housing unit revolvable by a second revolving part different from the first revolving part.

9. The construction machine according to claim 8, wherein the housing unit houses a mass body.

10. The construction machine according to claim 9, wherein the mass body is a hydrogen tank that stores hydrogen.

11. (canceled)

12. (canceled)

13. (canceled)

14. (canceled)

15. (canceled)

16. The construction machine according to claim 8, wherein the housing unit is provided at an upper part of the main body unit.

17. The construction machine according to claim 8, wherein the housing unit is provided at a lower part of the main body unit.

18. The construction machine according to claim 8, wherein a take-off and landing portion at which an unmanned flying object is capable of taking off and landing is provided in either one of the housing unit or the main body unit.

19. The construction machine according to claim 18, wherein a part of a power supply unit that supplies power to the unmanned flying object is provided in the take-off and landing portion.

20. (canceled)

21. The construction machine according to claim 8, wherein a solar panel that generates power is provided in either one of the housing unit or the main body unit.

22. (canceled)

23. The construction machine according to claim 1, wherein the main body unit includes a first body that houses the hydrogen tank and the fuel cell and a second body different from the first body to house hydraulic device that drives the working device.

24. The construction machine according to claim 1, comprising:
a storage battery that stores power generated by the fuel cell.

25. The construction machine according to claim 24, wherein the storage battery supplies the power to a motor of the construction machine.

26. The construction machine according to claim 1, comprising:
a cleaner that cleans a member by using water generated by the fuel cell.

27. The construction machine according to claim 8, wherein the main body unit houses a hydrogen tank that stores hydrogen and a fuel cell that is supplied the hydrogen from the hydrogen tank, and
the housing unit houses hydraulic device that drives the first working device and the second working device.
